(19) United States
(12) Patent Application Publication
(10) Pub. No.: US 2008/0037066 A1
(43) Pub. Date: Feb. 14, 2008

(54) Method and Apparatus for Providing Three-Dimensional Views of Printer Outputs

(76) Inventor: Charles M. Sauer, Lyons, CO (US)

Correspondence Address: DILLON & YUDELL, LLP, 8911 N CAPITAL OF TEXAS HWY, SUITE 2110, AUSTIN, TX, 78759, US

(21) Appl. No.: 11/463,627

(22) Filed: Aug. 10, 2006

(51) Int. Cl. G06F 3/12

(52) U.S. Cl. 358/1.18; 358/1.13

(57) ABSTRACT

A method for providing three-dimensional graphical representations of printer outputs is disclosed. A determination is initially made as whether or not a print datastream includes medium control. If the print datastream includes medium control, medium control information are extracted from an include medium map within the print datastream in order to rasterize the medium control on a texture map. The rasterized texture map is then applied to a three-dimensional page object. The three-dimensional page object is subsequently displayed on a display device for an end user to view.

### BACKGROUND OF THE INVENTION

1. Technical Field

The present invention relates to printing in general, and, in particular, to a method and apparatus for providing views of printer outputs. Still more particularly, the present invention relates to method and apparatus for providing three-dimensional graphical representations of printer outputs.

2. Description of Related Art

Software presentations of virtual sheets of paper in two-dimensional views on a display device are commonly provided by printing devices. Thus, an end user is able to view two-dimensional representations of the results of various options of the printing device has to offer before the output is printed. The options offered by the printing device may include one or more of the following:

1. jogging or offsetting a paper stack;

2. punch or staple finished prints;

3. back and front sheet sides; and

4. 1, 2, 4, . . . , n pages printed on a single front or back side of a sheet.

One drawback of two-dimensional views of printed sheets is that an end user is not allow to visualize the state of paper in a paper stack. Consequently, it would be desirable to provide an improved method and apparatus for providing graphical representations of printer outputs.

### SUMMARY OF THE INVENTION

In accordance with a preferred embodiment of the present invention, a determination is initially made as whether or not a print datastream includes medium control, such as finishing and/or stack offsets. If the print datastream includes medium control, medium control information are extracted from an include medium map within the print datastream in order to rasterize the medium control on a texture map. The rasterized texture map is then applied to a three-dimensional page object. The three-dimensional page object is subsequently displayed on a display device for an end user to view.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a printing system in which a preferred embodiment of the present invention is incorporated;

FIG. 2 is a high-level logic flow diagram of a method for providing three-dimensional graphical representations of printer outputs, in accordance with a preferred embodiment of the present invention;

FIG. 3 is a block diagram depicting information from a print datastream for generating a three-dimensional graphical representations of printer outputs, in accordance with a preferred embodiment of the present invention; and

FIG. 4 is a graphical illustration of an example of a three-dimensional graphical representations of printer outputs, in accordance with a preferred embodiment of the present invention.

### DETAILED DESCRIPTION OF A PREFERRED EMBODIMENT

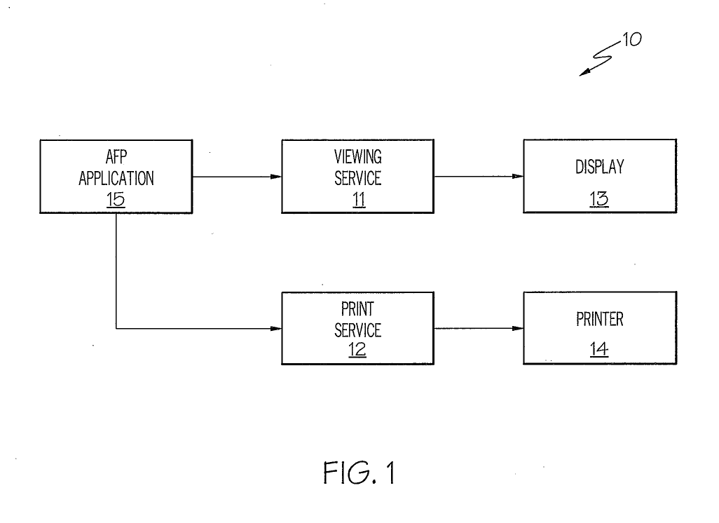

Referring now to the drawings and in particular to FIG. 1, there is depicted a block diagram of a printing system in which a preferred embodiment of the present invention is incorporated. As shown, a printing system 10 includes a viewing service 11, a print service 12, a display 13 and a printer 14. An advanced function presentation application 15 having a print datastream is sent to both viewing service 11 as well as print service 12. Viewing service 11 generates a graphical representation of the print datastream to be displayed on display 13. Print service 12 generates specific print information based on the print datastream, and the print information is utilized by printer 14 to produce a printout.

As mentioned above, two-dimensional views of virtual sheets of paper are commonly provided by a viewing service such as viewing service 11. The present invention provides a three-dimensional views of virtual sheets of paper by inserting additional information that are pertinent to the front, back and multiple sheets of paper to the same data that are used to present the two-dimensional view.

Specifically, data for providing a two-dimensional view are collected to generate a bitmap representation in a memory, and the data are subsequently applied to a three-dimensional surface with the attributes of a single sheet of paper. An end user may then rotate the stack of paper, rotate pages within the stack to view the front or back of each sheet, fold sheets of paper along the edges of stitch (finishing) marks, etc.

Finishing operations (e.g., staple or punch holes) collected from the data stream format (e.g., PostScript, MO:DCA, PCL, etc.) are applied to a three-dimensional objects that have the attributes of sheets of paper. The three-dimensional objects are then positioned within a viewport for display to an end user. Jog or offset stacking of sheets of paper within a printer tray can be displayed by layering one stack of virtual paper on another stack.

The three-dimensional view allows an end user to preview (or proof) printer output for pamphlets, booklets, stapled duplex pages, etc. The representation of the stack of sheets may include offset pages on the stack, finishing operations, or multi-page output on both the front and back sides of a single sheet of paper.

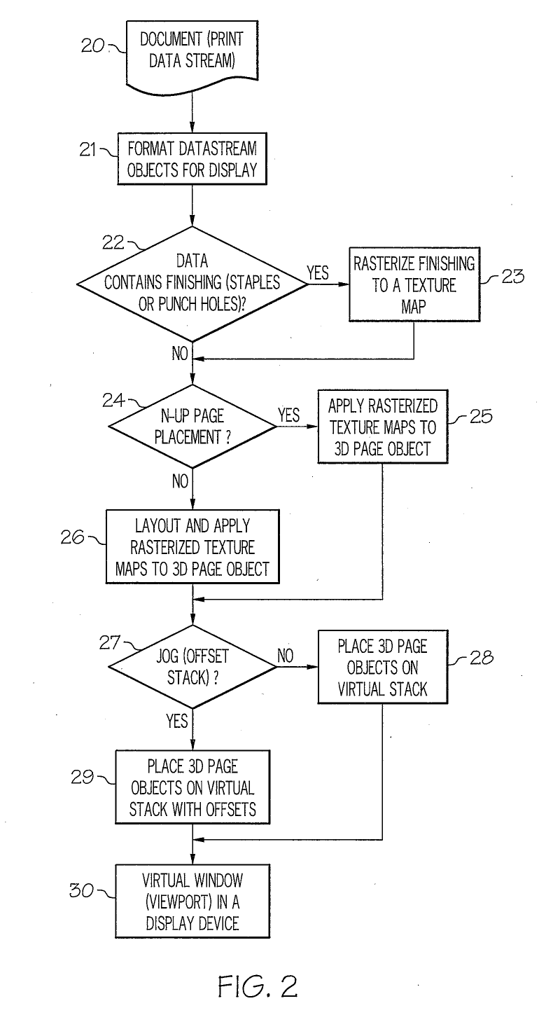

With reference now to FIG. 2, there is depicted a high-level logic flow diagram of a method for providing three-dimensional graphical representations of printer outputs, in accordance with a preferred embodiment of the present invention. Starting with a print datastream at block 20, objects from the print datastream are formatted for display, as shown in block 21.

The pages of the formatted datastream are then processed. Initially, a determination is made as to whether or not data from the print datastream contain finishing (such as staples or punch holes), as shown in block 22. If the data from the print datastream contain finishing, then the finishing are rasterized to a texture map, as depicted in block 23.

A next determination is made as to whether N-up page placement is required, as shown in block 24. If N-up page placement is required, rasterized texture maps are applied to a three-dimensional page object, as depicted in block 25. If N-up page placement is not required, the print pages are layout, and rasterized texture maps are applied to a three-dimensional page object, as shown in block 26.

Another determination is then made as to whether or not a jog (offset stack) is required, as depicted in block 27. If a jog is not required, then the three-dimensional page objects are placed on a virtual stack without offset, as shown in block 28. However, if a jog is required, then the three-dimensional page objects are placed on a virtual stack with offsets, as depicted in block 29. Finally, a three-dimensional view of the print output is displayed on a virtual window of a display device for the end user to view, as shown in block 30.

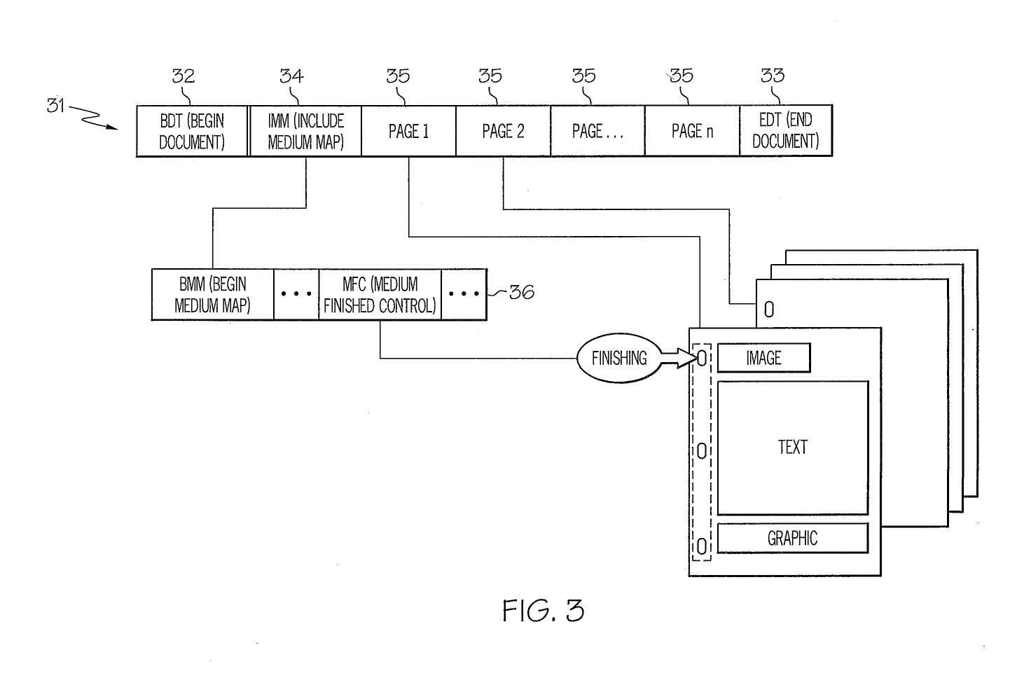

Referring now to FIG. 3, there is a block diagram depicting information from a print datastream for generating a three-dimensional graphical representations of printer outputs, in accordance with a preferred embodiment of the present invention. As shown, a print datastream 31 includes multiple blocks of data. For example, print datastream 31 begins with a begin document block 32 and ends with an end document block 33. Between begin document block 32 and end document block 33, print datastream 31 contains an include medium map block 34 and multiple print data blocks 35. In order to generate a three-dimensional graphical representations of printer outputs, information, such as medium finishing control 36, are extracted from include medium map block 34 in order to rasterize the graphics on a texture map, and the rasterized texture map is subsequently applied to a three-dimensional page object.

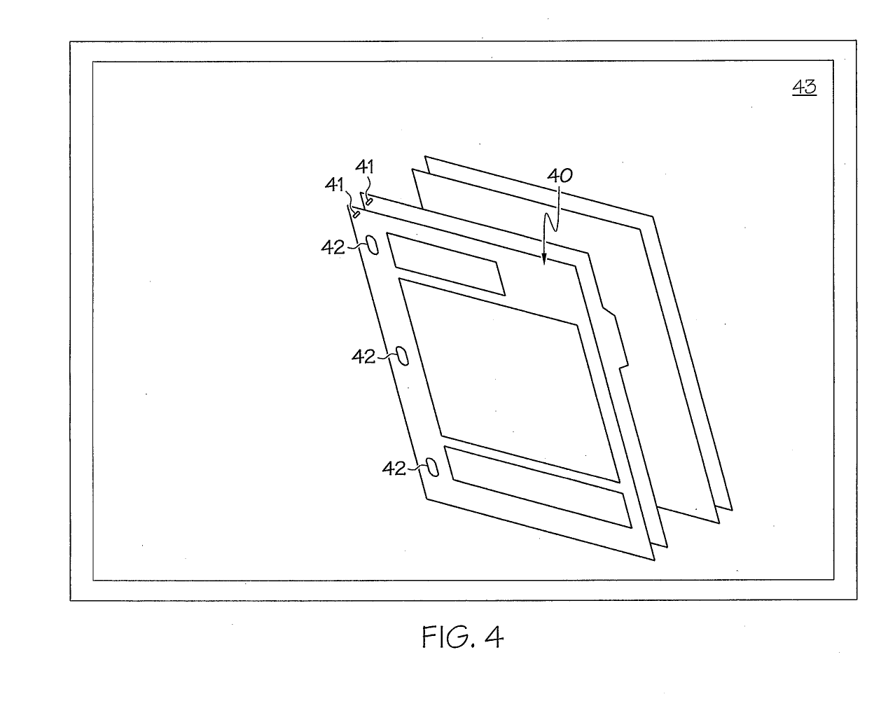

With reference now to FIG. 4, there is shown a graphical illustration of an example of a three-dimensional graphical representation of printer outputs, in accordance with a preferred embodiment of the present invention. As shown, a three-dimensional graphical representation 40 includes finishing such as staples 41 and punch holes 42. Three-dimensional graphical representation 40 can be viewed by a user via a viewport 43 within a display such as display 13 from FIG. 1.

As has been described, the present invention provides an improved method and apparatus for providing three-dimensional views of printer outputs. With a three-dimensional view of a print datastream, an end user is able to see the potential output from a printing device prior to actually submitting the job. Specifically, the end user can see the back or front side of a sheet by rotating any number of degrees (e.g., 47°, 82°, 173°, etc.) along any axis (including x, y or z). Alternately, the end user can see the jog or offset of sets of sheets when stacked. As a result, the end user can preview and proof the results of potentially expensive finishing or bindery operations prior to submitting jobs to the printing device.

It is important to note that the method of the present invention are also capable of being distributed as a computer program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for providing three-dimensional graphical representations of printer outputs, said method comprising:
determining whether or not a print datastream includes medium control;
in response to a determination that medium control is included in said print datastream, extracting medium control information from an include medium map within said print datastream;
rasterizing said medium control on a texture map with said extracted medium control information;
applying said rasterized texture map to a three-dimensional page object; and
displaying said three-dimensional page object on a display.

2. The method of claim 1, wherein said medium control is finishing.

3. The method of claim 2, wherein said finishing includes staples.

4. The method of claim 2, wherein said finishing includes punch holes.

5. The method of claim 1, wherein said medium control is stack offsets.

6. The method of claim 1, wherein said displaying further includes displaying said three-dimensional page object in any degree of rotation along any axis.

7. A computer usable medium having a computer program product for providing three-dimensional graphical representations of printer outputs, said computer usable medium comprising:
program code means for determining whether or not a print datastream includes medium control;
in response to a determination that medium control is included in said print datastream, program code means for extracting medium control information from an include medium map within said print datastream;
program code means for rasterizing said medium control on a texture map with said extracted medium control information;
program code means for applying said rasterized texture map to a three-dimensional page object; and
program code means for displaying said three-dimensional page object on a display.

8. The computer usable medium of claim 7, wherein said medium control is finishing.

9. The computer usable medium of claim 8, wherein said finishing includes staples.

10. The computer usable medium of claim 8, wherein said finishing includes punch holes.

11. The computer usable medium of claim 7, wherein said medium control is stack offsets.

12. The computer usable medium of claim 7, wherein said program code means for displaying further includes program code means for displaying said three-dimensional page object in any degree of rotation along any axis.

13. A printer capable of providing three-dimensional graphical representations of printer outputs, said printer comprising:
means for determining whether or not a print datastream includes medium control;
in response to a determination that medium control is included in said print datastream, means for extracting medium control information from an include medium map within said print datastream;
means for rasterizing said medium control on a texture map with said extracted medium control information;
means for applying said rasterized texture map to a three-dimensional page object; and
means for displaying said three-dimensional page object on a display.

14. The printer of claim 13, wherein said medium control is finishing.

15. The printer of claim 14, wherein said finishing includes staples.

16. The printer of claim 14, wherein said finishing includes punch holes.

17. The printer of claim 13, wherein said medium control is stack offsets.

18. The printer of claim 13, wherein said means for displaying further includes means for displaying said three-dimensional page object in any degree of rotation along any axis.
